(19) United States
(12) Patent Application Publication
(10) Pub. No.: US 2026/0313480 A1
(43) Pub. Date: Oct. 8, 2026

(54) CONFIGURATION OF MOBILITY PARAMETERS IN A CELLULAR NETWORK

(71) Applicant: Vodafone Group Services Limited, Newbury, Berkshire (GB)

(72) Inventor: Chandrika WORRALL, London (GB)

(21) Appl. No.: 19/481,590

(22) PCT Filed: May 8, 2024
(86) PCT No.: PCT/GB2024/051195

§ 371 Date: Nov. 5, 2025

(30) Foreign Application Priority Data
May 9, 2023 (GB) 2306820.8

(51) Int. Cl. H04W 36/00

(52) U.S. Cl. CPC H04W 36/0058

(57) ABSTRACT

Mobility of a User Equipment (UE) in a cellular network is considered. The UE may be configured with one or more mobility parameters, which are used for establishing a L1/L2 Triggered Mobility (LTM) measurement event based on at least one beam and/or cell measurement at the UE. Additionally or alternatively, one or more mobility parameters that are used for handover determination of a UE in a cellular network may be determined. A location for the UE is predicted based on location information for the UE. The one or more mobility parameters are determined based on the predicted location, using a trained machine learning model.

### TECHNICAL FIELD OF THE DISCLOSURE

The disclosure concerns configuring Lower-layer Triggered Mobility (LTM) of a User Equipment (UE) in a cellular network and determining one or more mobility parameters that are used for handover determination (based either on Radio Access Network Layer 3 or on Lower-layer triggered mobility) of a UE in a cellular network.

### BACKGROUND TO THE DISCLOSURE

In cellular networks (also termed mobile communication systems), mobility of the User Equipment (UE) during operation is important. A key aspect of mobility is handover, for example between base stations (cells) and/or more recently, between beams. As the UE moves in an area served by the mobile communication system or cellular network, the UE crosses cell boundaries. Then, the serving base station is updated in order for the UE to be served by the best cell with best radio quality link.

In systems configured according to standards set by the Third Generation Partnership Project (3GPP), there have been many advances and/or optimisations introduced to the mobility procedure. Conventionally, the mobility procedure is based on Radio Access Network (RAN) Layer 3 (L3) measurements and signalling, which includes Radio Resource Control (RRC). L3 measurements may be useful for radio resource management decisions that require a long-term view of channel conditions. Measurements may be filtered at L3 to remove the impact of fast fading and to help reduce short term variations in results. L3 measurements can be either ‘beam level’ or ‘cell level’, which can be reported within an RRC message: Measurement Report (MR). Beam level measurements may be generated directly from RAN Layer 1 (L1) measurements by applying L3 filtering. Cell level measurements may be derived from the L1 measurements using certain rules.

A specific issue with L3 mobility has been the so-called “ping-pong” effect, in which a UE performs repeated, often frequent, handover between two cells (or beams). This may especially occur where the UE is located in a geographical region and/or at a time when the radio propagation between the UE and the two cells is similar.

With the aim of guaranteeing a reliable handover to a best cell and avoiding the ping-pong effect, the radio measurements are typically averaged and hysteresis has been used in handover events in the cellular network. In addition, time-to-trigger and cell offset have been further introduced to the determination of handover events, to control the mobility of the UE to a best cell while mitigating possible drawbacks. These features have been introduced and successfully used in L3-based mobility, where the cell measurements are performed using Reference Signal Received Power (RSRP), Reference Signal Received Quality (RSRQ) and Received Signal Strength Indicator (RSSI) of the serving and/or target cell. L3-based mobility is discussed in detailed in 3GPP Technical Specification (TS) 38.331.

There have been discussions within 3GPP Working Groups to provide mobility based on RAN Layer 1 (L1) and/or Layer 2 (L2), for example see 3GPP WG2 document, R2-2300375. This has been termed L1/L2 Triggered Mobility (LTM). For example, the UE may provide L1 measurement reports to the network, and on their basis, the network (for example a gNB) changes the serving cell (or cells) for the UE through a L2 Media Access Control (MAC) Control Element (CE). It is envisaged that this would provide mobility enhancement.

Such measurement reports may be based on L1/L2 measurements such as a Demodulation Reference Signal (DMRS), Phase Tracking Reference Signal (PTRS), Sounding Reference Signal (SRS) and Channel State Information Reference Signal (CSI-RS). L1 measurements can be useful for procedures in which a reaction with minimal delay is desirable, for instance beam management procedures where the UE should switch rapidly between beams. Such L1 measurements may also permit fast cell management. Filtering of the L1 measurements is also being considered, to help remove the impact of noise and to improve measurement accuracy.

It is therefore desirable to improve the operation of LTM and to improve the speed of handover more generally, especially in view of the problems that may occur in UE mobility scenarios.

### SUMMARY OF THE DISCLOSURE

Against this background, the present disclosure provides a method for configuring L1/L2 Triggered Mobility (LTM) of a User Equipment (UE) in a cellular network according to claim 1, a computer program in line with claim 16 and a controller for an entity or User Equipment (UE) in a cellular network as defined by claim 17. Other preferred features are disclosed with reference to the claims and in the description below.

In one aspect, there may be considered configuration and/or operation of LTM of a UE in a cellular network. The UE is configured with one or more mobility parameters. The mobility parameter or parameters are used to establish a LTM measurement event (that is, a measurement trigger point on whether handover should take place) based on at least one beam and/or cell measurement at the UE. In particular, the mobility parameter or parameters may influence and preferably mitigate the ping-pong effect. In other words, the parameters may make it less likely for the UE to handover back and forth based on only a L1/L2 measurement for the target cell being better than a L1/L2 measurement for the serving cell. Particular examples of the mobility parameters include one or more of: a hysteresis parameter; a measurement offset parameter; and a time-to-trigger parameter. A L1/L2 measurement can be for a beam and/or a cell.

It has been recognised that, in certain scenarios, L1 filtering for noise removal is not sufficient to mitigate the drawback of a ping-pong effect. This may especially be the case in a densely populated environment. Thus, by introducing in L1/L2-based measurements mobility parameters, as used in L3-based measurements events, the reliability of L1/L2 based handover may be improved.

The L1/L2 mobility parameters are beneficially distinct (or at least, distinctly configurable) from any L3 mobility parameter or parameters (in particular, corresponding parameters). It will be appreciated that this does not necessarily mean that these parameters are never the same.

Typically, the configuration is effected by signalling from the network to the UE. For example, information relevant to setting the L1/L2 mobility parameter (or parameters) may be communicated to the UE in L1/L2 signalling and/or in L3 or Radio Resource Control (RRC) signalling. The L1/L2 signalling may use a Media Access Control (MAC) Control Element (CE) or a Downlink Control Information (DCI) field. In one embodiment, each L1/L2 mobility parameter may be communicated relative to a corresponding L3 mobility parameter. Then, the information communicated in the L1/L2 signalling may indicate an increase (step up) or decrease (step down) of the respective parameter by a predetermined or fixed amount, relative to L3 parameter.

Optionally, the L1/L2 measurement may be filtered over an averaging window or period for use in determining the LTM measurement event. The averaging window or period will typically be shorter than that used for L3 measurement filtering.

Advantageously, the L1/L2 mobility parameter or parameters are configured based on location information for the UE. Such location-based mobility parameter determination may also be applicable to L3 mobility.

In another aspect, there may be considered a method for determining one or more mobility parameters, as used for handover determination of a UE in a cellular network. Location information for the UE is used to predict a location. A trained machine learning model can then determine the mobility parameter or parameters based on the predicted location (or based on the location information). This may be applied to L1/L2 mobility parameter determination and/or to L3 mobility parameter determination. For instance, the machine learning model may output one or more of: a hysteresis parameter; a measurement offset parameter; and a time-to-trigger parameter.

Using Artificial Intelligence (AI) data training may enhance the handover decision, thereby improving the handover speed, performance and/or reliability. It has been appreciated that, if parameters such as hysteresis, time-to-trigger and cell offset are sub-optimally set, a direct impact on handover performance may result. As frequent unnecessary handover reduces the overall system performance and increases the handover interruption to the UE, use of AI-determined handover parameters may further reduce or mitigate a ping-pong effect.

The machine learning model may be trained based on historical data of UE mobility (location and corresponding attachment to a cell and/or beam), particularly of a large number of UEs and/or UE scenarios (at least 500, 1000, 5000, 10000, 50000, 100000, 500000 or more, for example). The machine learning model may be trained to determine the one or more mobility parameters so as to achieve one or more of: maximise efficiency of the cellular network; maximise utilisation of the cellular network; and minimise handover failure.

The combination of these aspects is possible. Certain features may be applicable to one or both aspects. For example, the location information for the UE may comprise one or more of: a current location for the UE; at least one previous location for the UE; a travel path for the UE; and a direction of travel for the UE. The location information for the UE may be based on information determined at the UE (for instance, a Global Navigation Satellite System, GNSS, including GPS or similar systems) and/or at the cellular network (for example, based on UE position tracking).

Either or both aspects may be implemented as a computer program and/or as a controller for a network entity (for example, a cell or base station, including a gNB) or a UE in a cellular network. A network entity or UE comprising such a controller may also be considered.

### BRIEF DESCRIPTION OF THE DRAWINGS

The approach of the disclosure may be put into practice in various ways, one of which will now be described by way of example only and with reference to the accompanying drawings in which:

FIG. 1 shows a communication flow diagram of a known signalling procedure for LTM;

FIG. 2 illustrates a block diagram of a cells according to a known Central Unit (CU)/Distributed Unit (DU) split architecture;

FIG. 3 shows a block diagram of protocol stack layers for known communication between cells according to the CU/DU split architecture;

FIG. 4 plots a cell or beam measurement over time for an example handover event, showing hysteresis, measurement offset and time-to-trigger parameters;

FIG. 5 illustrates a schematic block diagram for setting mobility parameters for LTM according to an embodiment of the disclosure;

FIG. 6 shows a schematic block diagram for training a machine learning model to determine mobility parameters according to an embodiment of the disclosure; and

FIG. 7 shows a schematic block diagram for using a trained machine learning model to determine mobility parameters according to an embodiment of the disclosure.

Where a drawing indicates a feature also shown in another drawing, identical reference numerals have been used.

### DETAILED DESCRIPTION OF PREFERRED EMBODIMENTS

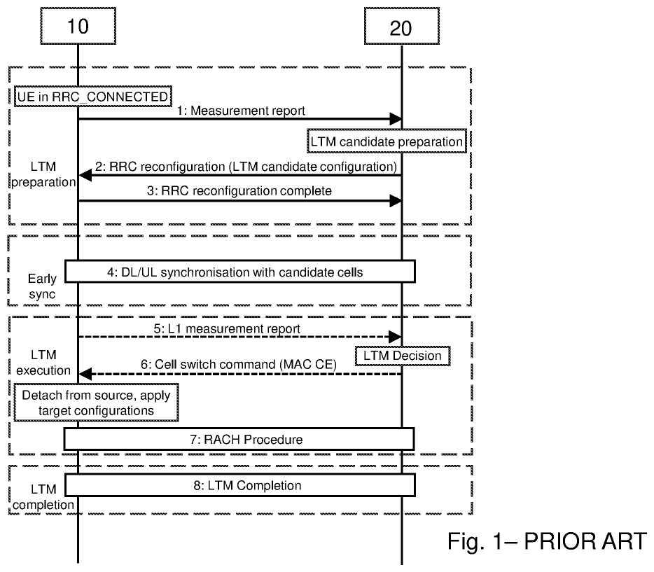

Embodiments according to the disclosure concern implementation of L1/L2 triggered mobility (LTM). In LTM, a gNB receives L1 measurement reports from each UE, and on this basis, the gNB changes the serving cell (or cells) of the UE through MAC CE signalling. Referring to FIG. 1, there is shown a communication flow diagram of a known signalling procedure for LTM, as appearing in R2-2300375. This is used initially to discuss LTM in detail with reference to 5G RAN.

A first stage is LTM preparation. The UE 10 begins in RRC_CONNECTED mode and in step 1, provides the gNB 20 with a L3 measurement report (MeasurementReport message). This allows the gNB 20 to decide to use LTM and initiate LTM candidate preparation. In step 2, the gNB 20 transmits an RRCReconfiguration message to the UE 10 including the configuration of one or multiple LTM candidate target cells. The candidate cell configurations can only be added, modified and released by network via RRC signalling. In step 3, the UE 10 stores the configuration of the one or multiple LTM candidate target cells and transmits a RRCReconfigurationComplete message to the gNB 20.

A second stage is early synchronisation. In step 4, the UE may perform downlink and/or uplink synchronization (and beneficially Tracking Area (TA) acquisition) with the one or multiple candidate target cells. This takes place before the UE 10 receives a LTM cell switch command.

A third stage is LTM execution. In step 5, the UE 10 performs L1 measurements on the configured one or multiple LTM candidate target cells and transmits L1/L2 measurement reports to the gNB 20 (for example on L1 or MAC). In step 6, the gNB 20 decides to execute LTM cell switch of the UE 10 to a target cell and transmits a MAC CE to the UE 10 triggering LTM cell switch. The cell switch trigger information, conveyed in a MAC CE, may contain at least a candidate configuration index. Cell-specific, radio bearer and/or measurement configurations may be part of an LTM candidate cell configuration. The UE 10 then switches to the configuration of the LTM candidate target cell (for example, by detaching from the source and applying target configurations). In step 7, the UE 10 may perform a random-access channel (RACH) procedure towards the target cell, if the TA is not available. Contention-based Random Access (CBRA) or Contention free Random Access (CFRA) may be performed. The UE may also skip the random-access procedure of step 7, if UE does not need to acquire TA for the target cell during cell switch. RACH resources for CFRA are provided in RRC configuration.

A fourth stage is LTM completion. In step 8, the UE indicates successful completion of the LTM cell switch towards the target cell.

Subsequent LTM may be done by repeating the early synchronization, LTM execution, and LTM completion steps without releasing other candidates after each LTM completion.

Whether the UE performs partial or full MAC reset, re-establishes Radio Link Control (RLC) and/or performs data recovery with Packet Data Convergence Protocol (PDCP) during cell switch is explicitly controlled by the network. There are two options for resetting L2. In a first option, the UE determines whether the switch is intra-DU or inter-DU and the follows different rule or configuration for these two cases, which controls whether to reset or not reset. Determination could be based on configuration (for example, of a DU ID, cell group id etc.). In a second option, the UE receives a command to reset or not reset by MAC CE signalling. For UE processing, the following list (not exhaustive) is assumed to be performed after receiving the cell switch command: MAC/RLC reset (when configured); and RF retuning (for example, for inter-frequency) and/or baseband retuning.

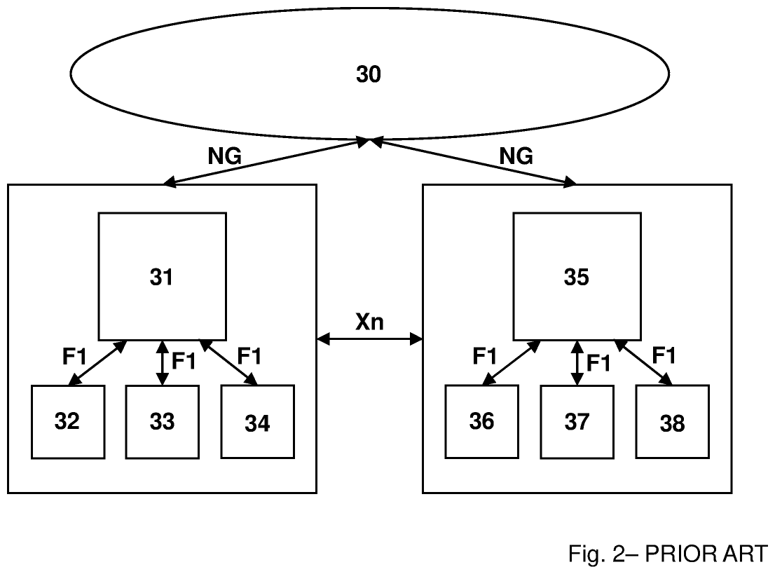

LTM may be particularly applicable to Central Unit (CU)/Distributed Unit (DU) split architecture. Referring next to FIG. 2, there is illustrated a block diagram of a cells according to a known CU/DU split architecture. This shows: core network 30; a first gNB-CU 31; a first gNB-DU 32; a second gNB-DU 33; a third gNB-DU 34; a second gNB-CU 35; a fourth gNB-DU 36; a fifth gNB-DU 37; and a sixth gNB-DU 38. The core network 30 interfaces with the first gNB-CU 31 and the second gNB-CU 35 via NG interfaces. The first gNB-CU 31 and the second gNB-CU 35 interface with each other using a Xn interface. Each CU interfaces with its respective DUs using F1 interfaces.

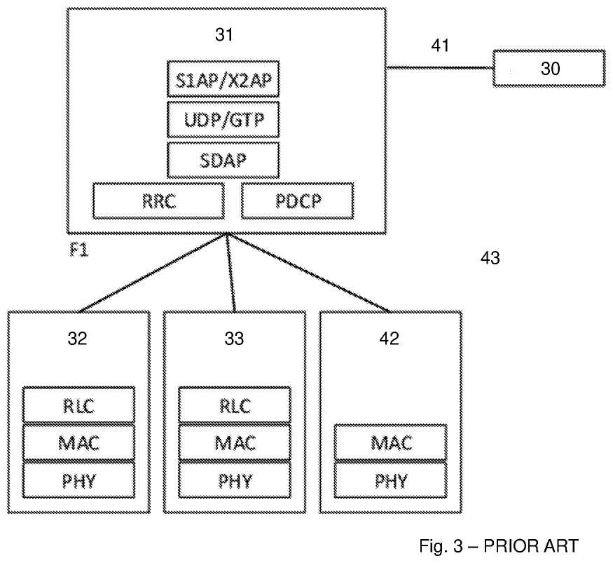

Referring now to FIG. 3, there is shown a block diagram of protocol stack layers for known communication between cells according to the CU/DU split architecture. Where the same features are shown as those in FIG. 2, identical reference numerals have been used. The core network 30 interfaces with the first gNB-CU 31 via a NG interface provided by backhaul network 41. The F1 interfaces between the first gNB-CU 31 and each of the first (5G) gNB-DU 32, the second (4G) gNB-DU 33 and a Wireless LAN DU 42 are provided by the Fronthaul/Midhaul network 43.

The following principles may apply to LTM. First, candidate cell configuration can be provided as delta configurations on top of a reference configuration. The reference configuration is managed separately and a UE stores the reference configuration as a separate configuration. The user plane is continued whenever possible (for example, intra-DU), without reset, with the target to avoid data loss and the additional delay of data recovery. Security is not updated in LTM. Subsequent LTM between candidates (that is, where the UE does not release other candidate cell configurations after LTM is triggered) can be performed without RRC reconfiguration.

LTM may support both intra-gNB-DU and intra-gNB-CU inter-gNB-DU mobility. LTM may also support inter-frequency mobility, including mobility to an inter-frequency cell that is not a current serving cell. For example, the following scenarios may be supported: Primary Cell (PCell) change in a non-Carrier Aggregation (CA) scenario, PCell change without Secondary Cell (SCell) change in a CA scenario, PCell change with SCell change (or changes) in CA scenario, including where a) the target PCell or target SCell (or cells) is not a current serving cell (CA-to-CA scenario with PCell change), b) the target PCell is a current SCell; or c) the target SCell is the current PCell; and a dual connectivity scenario, at least for the PSCell change without Master Node (MN) involvement case, that is intra-Secondary Node (SN).

The general operation of LTM is discussed above. Some aspects of the disclosure apply approaches used in L3 handover to LTM, for example hysteresis, measurement offset and time-to-trigger parameters. Therefore, the use of these approaches in L3 handover is discussed now, to assist with understanding. 3GPP TS 38.331 defines a number of L3 measurement events, which have been introduced to cater for different deployment scenarios, heterogeneous network implementations, inter-RAT scenarios, or similar.

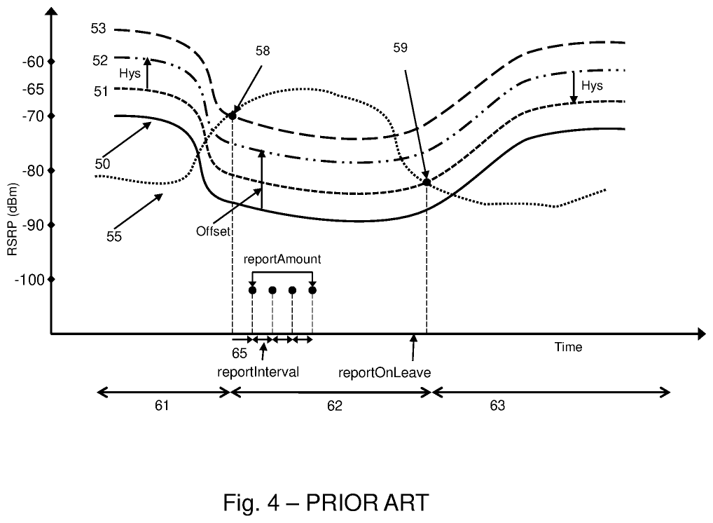

Referring next to FIG. 4, there is plotted a measurement over time for an example handover event. Cell measurements are shown, but this can be equivalently applied to beam measurements. The specific handover event discussed with reference to this drawing is termed (in 3GPP TS 38.331) “A3” and concerns a situation where a neighbour cell (or beam) measurement becomes better than a serving measurement by more than a measurement offset amount. A serving cell measurement 50 and a neighbouring cell measurement 55 are depicted in three phases: a first phase 61, in which the network keeps the UE attached to the serving cell until a trigger condition 58 is met; a second phase 62, in which the network starts to decide if the UE should handover to the neighbouring cell until a cancel condition 59 is met; and a third phase 63, in which the network cancels the decision for handover.

Triggering of the A3 event (corresponding with the second phase 62 beginning) is defined by the following equation:

$$Mn + Ofn + O c n - Hys > Mp + Ofp + Ocp + Off ,$$

where:
Mn is the measurement of the signal received from the neighbouring cell;
Ofn is the specified offset related to the frequency of the neighbouring cell;
Ocn is the specific offset related to the neighbouring cell;
Mp is the measurement of the level received on the serving cell;
Ofp is the specific offset linked to the frequency of the serving cell;
Ocp is the specific offset linked to the serving cell;
Off is the specific offset related to this event; and
Hys is the hysteresis.

The A3 event is stopped (corresponding with the third phase 63 beginning) when the measurement of the signal received from the neighbouring cell becomes lower than that of the serving cell, as defined by the following equation:

$$MN + Ofn + Ocn + Hys < Mp + Ofp + Ocp + Off$$

The A3 event can be used for an intra-frequency or inter-frequency handover procedure.

It can be seen that the offsets are added to the serving cell measurement to control the ping-pong effect. These are shown by adjusted serving cell measurements 51 and 53. Multiple offsets are defined, specific to frequency and cell. Similarly, the offsets can be added to neighbouring cell measurements to mitigate the channel quality fluctuation of a neighbouring cell (not shown in FIG. 4). Hysteresis is added to the serving cell measurement (or equivalently, subtracted from the neighbouring cell measurement) for triggering the A3 event, but subtracted from the serving cell measurement (or equivalently, added to the neighbouring cell measurement) for stopping the A3 event. This is shown by adjusted serving cell measurement 52. This again mitigates the ping-pong effect and channel quality fluctuation. It should be noted that hysteresis and offset are considered for the measurements event itself.

Another mechanism for mitigating ping-pong effect and channel quality fluctuation is a time-to-trigger parameter 65. When the trigger condition is met, the trigger criteria is checked for a number of instances during a configured time period (time-to-trigger 65). If the trigger criterion or criteria are continuously met during the time-to-trigger period, the measurements are reported to the network.

The hysteresis, time to trigger and measurement offset parameters are provided to the UE in measurement objects at the measurement configuration and are then used by the UE when performing measurements. This is more beneficial as the measurements would not need to be reported unnecessarily, thereby saving radio resources.

According to an aspect of the disclosure, mobility parameters such as hysteresis, offset and time-to-trigger are introduced for L1/L2 based measurements events. L1/L2 based mobility is intended to support fast cell switch and/or handover. Therefore, it is desirable to not introduce extra latency due to the L1 measurement filtering and to set these parameters (hysteresis, offset and time-to-trigger) optimally and faster. Fast configuration or updates of these parameters may affect the success of fast cell switch and/or handover. Therefore, in addition to use of L3 signalling for measurement configuration, the disclosure targets use of L1/L2 signalling, specifically the MAC CE field or DCI field in L1 signalling to update these parameters (hysteresis, offset, time-to-trigger) to the UE. In one embodiment, the parameter update is to step up or down from the L3 configured parameter values.

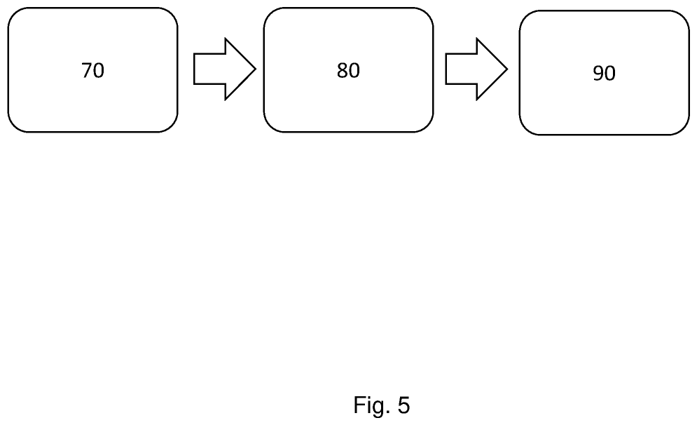

Referring next to FIG. 5, there is illustrated a schematic block diagram for setting mobility parameters for LTM according to an embodiment of the disclosure. In general terms, this considers configuration of L1/L2 Triggered Mobility (LTM) of a UE in a cellular network. This configures the UE with one or more mobility parameters. The one or more mobility parameters are used for establishing a LTM measurement event based on at least one beam and/or cell measurement at the UE. For example, these parameters may be implemented to reduce or mitigate a ping-pong effect and/or the effect of channel quality fluctuation on handover. For example, the one or more mobility parameters may comprise one or more of: a hysteresis parameter; a measurement offset parameter; and a time-to-trigger parameter.

In RRC configuration step 70, the UE may be configured for L1/L2-based triggered mobility (LTM) in RRC configuration. This may involve configuring the UE with the one or more of: a hysteresis parameter; a measurement offset parameter; and a time-to-trigger parameter, each of which being used for establishing a measurement and/or handover event for LTM. The RRC configuration in step 70 may be performed by communicating information in respect of the one or more mobility parameters from the cellular network to the UE in Radio Resource Control (RRC) signalling. RRC signalling may include one or more of: measurement events; measurements objects; measurements report configuration; and other similar signalling. The information may be the at least one mobility (or handover) parameter, which may be used for establishing a measurement event.

In LTM configuration step 80, the one or more mobility parameters are communicated from the cellular network to the UE in L1/L2 signalling. For instance, the L1/L2 signalling may use a Media Access Control (MAC) Control Element (CE) or a Downlink Control Information (DCI) field. Advantageously, the one or more mobility parameters are communicated from the cellular network to the UE relative to the information communicated in respect of the one or more mobility parameters from the cellular network to the UE in RRC signalling. In one embodiment, this communication indicates an increase or decrease of the one or more mobility parameters by a predetermined or fixed amount, relative to the information communicated in respect of the one or more mobility parameters from the cellular network to the UE in RRC signalling. For instance, the communication may indicate a step up or step down (by the predetermined or fixed amount) from the corresponding RRC parameter and/or from the existing LTM parameter. In some embodiments, the one or more mobility parameters may be configured based on location information for the UE. This will be discussed further below.

In LTM operation step 90, the one or more mobility parameters are used to determine a LTM measurement event. For example, each of the one or more mobility parameters may be added to or subtracted from a L1/L2 measurement of a serving cell or beam and/or a neighbouring cell or beam. Each parameter may be applied individually, for example based on scenario-dependent rules. Optionally, the LTM measurement event may be established based on filtering of the at least one beam and/or cell measurement (L1/L2 measurement) at the UE over an averaging window or period.

As noted above, it may be advantageous for mobility parameters (whether LTM or L3) to be established based on the UE location. For example, it may be identified that certain locations have a higher risk of ping pong effect than others and this may affect an optimal choice of mobility parameters. Other factors may also affect the optimal choice of mobility parameter or parameters, for instance, time, radio propagation (which may be weather-dependent); throughput; cell load; and other factors or information on incidents that may affect cell load and/or load distribution in a geographical area (for example, a road accident or mass attendance event may affect load).

It has been identified that Artificial Intelligence (AI), more specifically a Machine Learning (ML) model may be used for determining the mobility parameter or parameters. The AI-based determination (and/or training of the ML model) could either be at the network or at the UE. At the network, the network may collect data from many users who would have experience of a similar propagation model, similar user paths and the like for use as training data. The model may then compute optimal parameters for a given UE, at a given location and time. At the UE-based AI model, the model could be kept simple and be provided with assistance information from the network to decide optimal parameters at the given location and time for the UE.

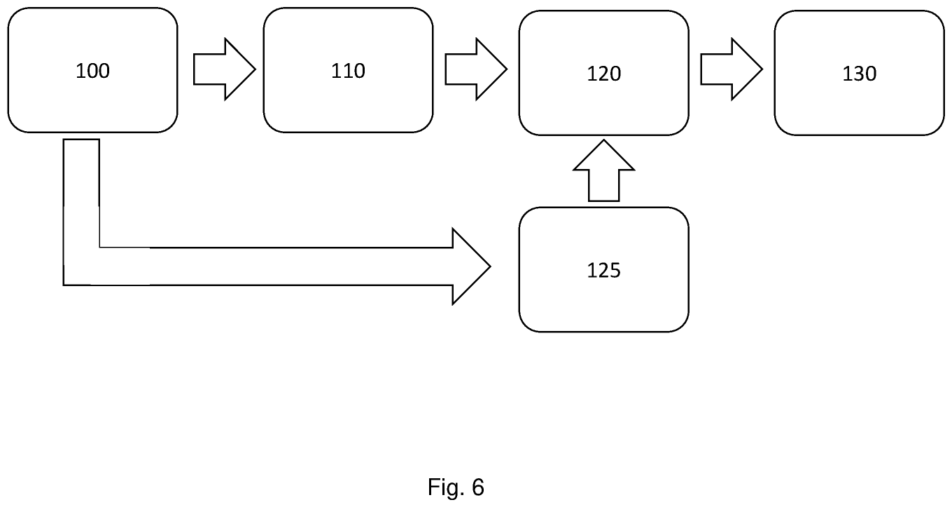

These will now be discussed in more detail with reference to FIG. 6, in which there is shown a schematic block diagram for training a machine learning model to determine mobility parameters according to an embodiment of the disclosure. This represents a first phase of the AI-based approach: model training. Historical data 100 is obtained from users in various deployment scenarios, propagation conditions, paths, routes and/or locations, user scenarios. This data indicates at least UE location information and cell (and/or beam) attachment. It may also indicate further information, as will be discussed below. The term path or route as used herein may include, for instance, a road, train line, boat or air path or similar.

The historical data 100 is provided as training data to one or more machine learning (ML) algorithms 110. In practice, multiple ML algorithms 110 are used, each configured to identify a best-fit pattern between the UE location and cell (or beam) attachment. These are typically self-supervised ML algorithms, although other types of learning may be adopted. The ML algorithms 110 may include Neural Networks (NNs), for example Convolutional Neural Networks (CNNs) and one or more NNs may be deep. From the outputs of the ML algorithms 110, a single pattern is identified for the relationship between UE location and cell (or beam) attachment.

Further model training 120 then takes place. This aims to train the model to determine mobility parameters as an output, based on UE location as an input. The historical data 100, particularly including more a detailed set of mobility related parameters, may be provided as an input to a fine-tuning block 125, which configures the model training 120 accordingly. The result of this training is a predictive model 130. This model may be optimised for maximising efficiency of the cellular network or utilisation of the cellular network and/or minimisation of handover failure. It may use a metric for attachment and/or handover success or failure for this purpose.

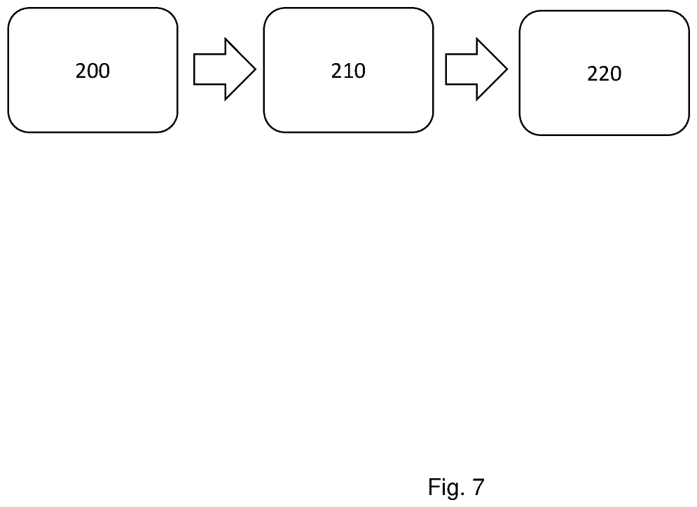

Referring now to FIG. 7, there is shown a schematic block diagram for using a trained machine learning model to determine mobility parameters according to an embodiment of the disclosure. This represents a second phase of the AI-based approach: use of the model in UE operation. Current UE data 200 is compiled, for example one or more of: UE location (for instance, rough or accurate location information); path or route; travel direction; and travel path and/or location history. The compilation may be based on information determined at the UE (for example, by GNSS) and/or information determined at the cellular network (reported by the UE, determined by other tracking methods, such as current and/or historical cell or beam attachment, triangulation or similar).

The current UE data is provided to the trained predictive (ML) model 210. This has two aspects. First, it predicts future location (or locations) for the UE, which may include one or more of: user direction; travel path; and travel pattern. Then, it uses the predicted location (or locations) together with the trained model 130 from phase 1 to determine one or more mobility parameters. For example, these may include one or more of: hysteresis; time-to-trigger; and channel offset values. There may be other inputs to the ML model 210, for example one or more of: time; radio propagation; weather; user preferences; throughput (in one or more of the individual cells concerned, for example serving cell or neighbouring cells and/or the network overall); and cell load. These other inputs may also be used by the ML model 210 to determine the one or more mobility parameters.

In general terms, this aspect may provide a method for determining one or more mobility parameters. The one or more mobility parameters are used for handover determination of a UE in a cellular network. The method comprises: predicting a location for the UE based on location information for the UE; and determining the one or more mobility parameters based on the predicted location, using a trained machine learning model. Optionally, the trained machine learning model may also be used to predict the location for the UE, but alternatively, this can be achieved separately. This aspect may be combined with the configuration of one or more LTM mobility parameters as discussed herein. The one or more mobility parameters may be for LTM and/or for L3 handover. Preferably, the one or more mobility parameters comprise one or more of: a hysteresis parameter; a measurement offset parameter; and a time-to-trigger parameter.

In some embodiments, the machine learning model is trained to determine the one or more mobility parameters so as to achieve one or more of: maximise efficiency of the cellular network; maximise utilisation of the cellular network; and minimise handover failure.

The location information for the UE may comprises one or more of: a current location for the UE; at least one previous location for the UE; a travel path for the UE; and a direction of travel for the UE. The location information for the UE may be based on information determined at the UE and/or at the cellular network.

Any of the methods described herein may be implemented as a computer program. The computer program may be configured to control a MS, UE and/or a network node or entity to perform any method according to the disclosure. A network node of a cellular network (for example, a gNB) may also be provided, configured to operate in accordance with certain methods disclosed herein. For example, the network node may include a processor and at least one communication interface, particularly comprising one or both of a transmitter and receiver. A UE may also be provided, configured to operate in accordance with certain methods disclosed herein. The UE may likewise include a processor and at least one communication interface, particularly comprising one or both of a transmitter and receiver.

Although specific embodiments have now been described, the skilled person will understand that various modifications and variations are possible. For example, whilst the disclosure is described in relation to existing network architecture, it will be understood that changes to the architecture (and/or nomenclature) are possible, but the present disclosure may still be applicable in this case. Also, combinations of any specific features shown with reference to one embodiment (or aspect) or with reference to multiple embodiments (or aspects) are also provided, even if that combination has not been explicitly detailed herein.

1. A method for configuring L1/L2 Triggered Mobility (LTM) of a User Equipment (UE) in a cellular network, the method comprising:
configuring the UE with one or more mobility parameters, the one or more mobility parameters being configured for establishing a LTM measurement event based on at least one beam and/or cell measurement at the UE.

2. The method of claim 1, wherein the one or more mobility parameters are distinct from at least one mobility parameter that is configured for establishing a L3 measurement event.

3. The method of claim 1, wherein the configuring comprises communicating information in respect of the one or more mobility parameters from the cellular network to the UE in L3 or Radio Resource Control (RRC) signaling.

4. The method of claim 3, wherein the one or more mobility parameters are communicated from the cellular network to the UE in L1/L2 signaling.

5. The method of claim 4, wherein the L1/L2 signaling uses a Media Access Control (MAC) Control Element (CE) or a Downlink Control Information (DCI) field.

6. The method of claim 4, wherein the configuring comprises communicating the one or more mobility parameters from the cellular network to the UE relative to the information communicated in respect of the one or more mobility parameters from the cellular network to the UE in L3 or RRC signaling.

7. The method of claim 6, wherein the information communicated in respect of the one or more mobility parameters from the cellular network to the UE in L3 or RRC signaling comprises at least one mobility parameter that is configured for establishing a L3 measurement event.

8. The method of claim 6, wherein the communicating indicates an increase or decrease of the one or more mobility parameters by a predetermined or fixed amount, relative to the information communicated in respect of the one or more mobility parameters from the cellular network to the UE in L3 or RRC signaling.

9. The method of claim 1, wherein the LTM measurement event is established based on filtering of the at least one beam and/or cell measurement at the UE over an averaging window or period.

10. The method of claim 1, wherein the one or more mobility parameters are configured based on location information for the UE.

11. A method for determining one or more mobility parameters, the one or more mobility parameters being configured for handover determination of a User Equipment (UE) in a cellular network, the method comprising:
predicting a location for the UE based on location information for the UE; and
determining the one or more mobility parameters based on the location that was predicted, using a trained machine learning model.

12. The method of claim 11, wherein the trained machine learning model is trained to determine the one or more mobility parameters such that one or more of: efficiency of the cellular network is maximized; utilization of the cellular network is maximized; and handover failure is minimized.

13. The method of claim 10, wherein the one or more mobility parameters are determined based on a location for the UE that was predicted based on location information for the UE using a trained machine learning model.

14. The method of claim 11, wherein the location information for the UE:
comprises one or more of: a current location for the UE; at least one previous location for the UE; a travel path for the UE; and a direction of travel for the UE; and/or
is based on information determined at the UE and/or at the cellular network.

15. The method of claim 1, wherein the one or more mobility parameters comprise one or more of: a hysteresis parameter; a measurement offset parameter; and a time-to-trigger parameter.

16. A computer program product comprising a non-transitory computer readable storage medium having computer readable program code embodied therein, which, when executed by a processor, causes the processor to perform the method of claim 1.

17. A controller for an entity or User Equipment (UE) in the cellular network, wherein the controller is configured to perform the method of claim 1.
